(19) United States
(12) Patent Application Publication
(10) Pub. No.: US 2018/0032153 A1
(43) Pub. Date: Feb. 1, 2018

(54) HAND-HELD ACTUATOR FOR CONTROL OVER AUDIO AND VIDEO COMMUNICATION

(71) Applicant: Michael Joshua Samuels, Weston, MA (US)

(72) Inventor: Michael Joshua Samuels, Weston, MA (US)

(21) Appl. No.: 15/660,100

(22) Filed: Jul. 26, 2017

Related U.S. Application Data
(60) Provisional application No. 62/367,781, filed on Jul. 28, 2016.

(51) Int. Cl. G06F 3/0346

(52) U.S. Cl. CPC G06F 3/0346

(57) ABSTRACT

A first icosidodecahedron includes a motion sensor that provides data indicative of motion of the first icosidodecahedron. The accelerometer provides this data to a microprocessor, which then determines a state vector corresponding to the data. The microprocessor provides the state data to a communication interface that is configured to communicate the state vector to a control computer, which then selects corresponding output to be provided to either a speaker or a display or both.

### CROSS-REFERENCE TO RELATED APPLICATION

This application claims the benefit of the Jul. 28, 2016 priority date of U.S. Provisional Application No. 62/367,781, the content of which is incorporated herein by reference in its entirety.

### FIELD OF INVENTION

The invention pertains to control over communication of audio and/or visual information, and in particular, to hand-held actuators to control such communication.

### BACKGROUND

The transition to ubiquitously digital audio and video synthesis has birthed many new user interface paradigms previously unimaginable in the analog age. Digital controllers geared towards live performance have exploded in both variety and complexity in recent years, however many such controllers merely echo or recycle the design paradigms of their analog forerunners. For example, digital keyboards and digital turntables do little more than mimic their familiar analog predecessors.

### SUMMARY

The invention is based on the recognition that a set of one or more polyhedral solids with high internal symmetry can be used as a basis for constructing an interaction paradigm for performers who wish to communicate audio, video, and audiovisual material. Such solids provide an adaptable framework for creating music and visual art in real-time, without a steep learning curve.

The invention features an apparatus comprising a set of one or more polyhedra, at least one of which is an icosidodecahedron. Each polyhedron houses a motion sensor that allows a user to manipulate audiovisual data streams in a variety of creative performance contexts. The apparatus triggers or otherwise modulates distinct, programmable audiovisual state outcomes associated with the motion of the polyhedra. Examples of such motion include rotation and translation, as well as motion relative to an object in a reference frame.

In one embodiment, a single icosidodecahedron in communication with a receiving computer may comprise the entire interface apparatus. In other embodiments, this manifestation may be elaborated to include multiple polyhedra, at least one of which is an icosidodecahedron, with the composition and permutation of their individual states generating an exponentially broader array of state outcomes.

Each polyhedron comprises a solid molded housing, a motion sensor, a radio transceiver, a microprocessor, and a power source. A control computer communicates with the set of polyhedra and converts the raw physical sensor data to context-appropriate output such as pre-determined sounds, parameters representing timbre, lights, colors, and/or shapes.

As used herein, a set of polyhedra includes a set that has only one polyhedron, notwithstanding the use of the plural form, the use of which is only a result of having to comply with the forms of the English language.

In one aspect, the invention features a first polyhedron having a motion sensor that provides kinematic data indicative motion of the first polyhedron. The motion sensor provides this data to a microprocessor, which then determines a state vector corresponding to the motion. The microprocessor provides the state data to a communication interface that is configured to communicate the state vector to a control computer. Such an interface can be a wireless interface or a wired interface. The polyhedron, in this case, is an icosidodecahedron.

Some embodiments also include the control computer. In these embodiments, the control computer is configured to receive the state vector and to select an output corresponding to the state vector. The output can be audio, video, or both. Such output can be provided to a speaker, a display, or both. Examples of output include a resonant frequency, a delay period, a reverb time, a track start point, a track stop point, a cross-fader distribution between parallel tracks, color saturation of video track output, an image distortion gradient, and hue.

In some embodiments, the sensor comprises a 9-degree-of-freedom sensor.

Some embodiments also include a second polyhedron, or even a plurality of additional polyhedrons. The additional polyhedron has internal electronics similar to the first polyhedron. Among these embodiments are those that further comprise a control computer is configured to receive the state vectors from the first and second polyhedrons and to select an output corresponding to the state vectors. The different polyhedrons are in some cases the same kind of polyhedron and in other cases different kinds of polyhedron. At least one polyhedron from the set is an icosidodecahedron.

These and other features of the invention will be apparent from the following detailed description and the accompanying figures, in which:

### BRIEF DESCRIPTION OF THE FIGURES

FIG. 1 shows a performance artist acting on a polyhedron set to generate a state vector, the polyhedron set having at least one icosidodecahedron;

FIG. 2 shows a DJ controlling sonic parameters in a specific embodiment of the system shown in FIG. 1;

FIG. 3 shows signal-flow starting from the polyhedron set of FIG. 1, to control the patch, and to state space;

FIG. 4 shows signal-flow from a single-element polyhedron set to state space;

FIG. 5 shows signal-flow from a two-element polyhedron state to state space, illustrating the effect of orientation permutations;

FIG. 6 shows a detailed view of the state-vector assignment process;

FIG. 7 shows a detailed view of the icosidodecahedron shown referred to in FIG. 1;

FIG. 8 shows views of the icosidodecahedron of FIG. 7 from three orthogonal axes; and

FIGS. 9 and 10 show data-flow diagrams between the manipulated polyhedron and an output device.

### DETAILED DESCRIPTION

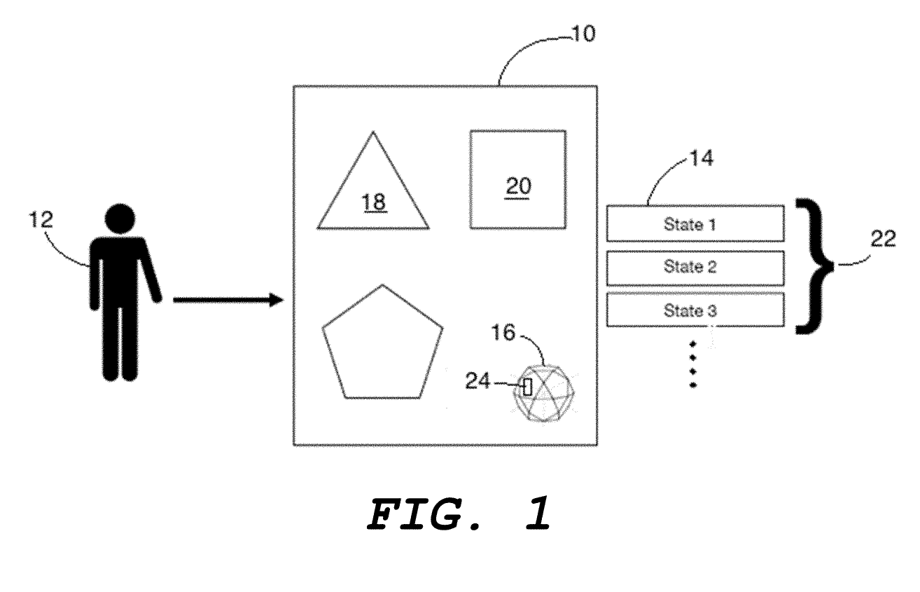

Performance artists such as musicians, DJs, video artists, and light/sound painters often use hardware devices to initiate or “trigger” specific multimedia events. FIG. 1 shows a polyhedron set 10 for accepting motion input from a performance artist 12 to define a state vector 14 that results in communication of certain content, which can be audio and/or video content.

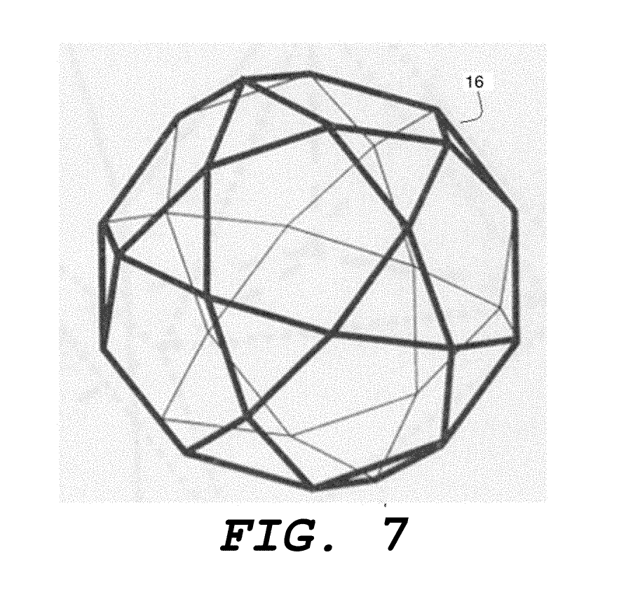

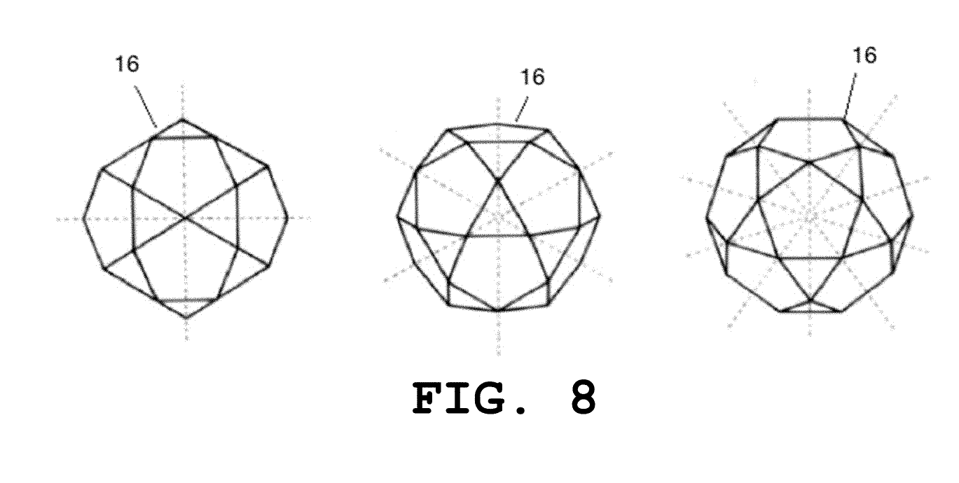

The polyhedron set 10 includes at least one icosidodecahedron 16, details of which can be seen in FIG. 7 as well as from three orthogonal directions in FIG. 8. The icosidodecahedron 16 can be any one of several variants of an icosidodecahedron, including a truncated icosidodecahedron and a complete icosidodecahedron.

The polyhedron set 10 can have one or more polyhedral forms. FIG. 1, in particular, shows a pyramid 18 and a cube 20 as examples of other polyhedral forms.

The use of a polyhedral form having discrete faces promotes precise orientation by the performance artist 12. For example, it is a simple matter for a performance artist 12 to change the orientation of a polyhedron by an angle that corresponds to one facet or face, whereas it may be difficult for a performance artist 12 to change the orientation of a sphere by some number of degrees. In effect, the polyhedron partitions a continuous orientation space having an infinite number of orientations into a discrete space having a finite number of states that are easier for a user to transition in and out of. Having at least one polyhedron be an icosidodecahedron 16 is particularly useful because of the musical significance inherent in the geometry of the icosidodecahedron.

A set of two or more state vectors 14 defines a state space 22 having plural states. These states might correspond to an instruction to play content and an instruction to stop playing content. Although there are only a discrete number of facets, the icosidodecahedron 16 includes a motion sensor 24 that renders it sensitive to motion, which is inherently continuous. As a result, the number of states can be infinite. Each action carried out by a performance artist 12 on the polyhedron set 10 results in a state vector 14.

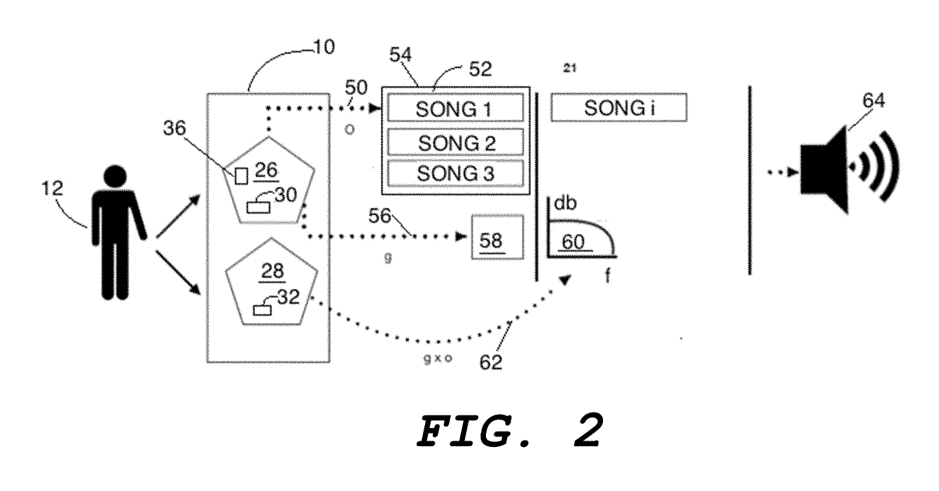

FIG. 2 illustrates one embodiment in which the performance artist 12 who interacts simultaneously with a first polyhedron 26 and a second polyhedron 28 of a polyhedron set 10. The first polyhedron 26 includes first motion-sensor 30 for providing data indicative of motion thereof. Similarly, the second polyhedron 28 includes second motion-sensor 32 for providing data indicative of motion thereof.

Examples of motion-sensors 24, 30, 32 that provide such data include accelerometers of the type found in typical mobile devices, gyroscope, and inertial measurement units. Further examples of such motion-sensors 24, 30, 32 include circuitry that permits the creation of one or more touch-sensitive faces on the polyhedron 26, 28. Such a touch-sensitive face detects motion of, for example, a finger that moves between a point on the touch-sensitive face and a point that is not on the touch-sensitive face.

The following discussion describes the icosidodecahedron. However, it is understood to be applicable to any polyhedron.

As noted in connection with FIG. 1, the icosidodecahedron 16 houses a motion sensor 24. The motion sensor 24 provides information from which it is possible to infer relative movement between the icosidodecahedron 16 and a reference frame.

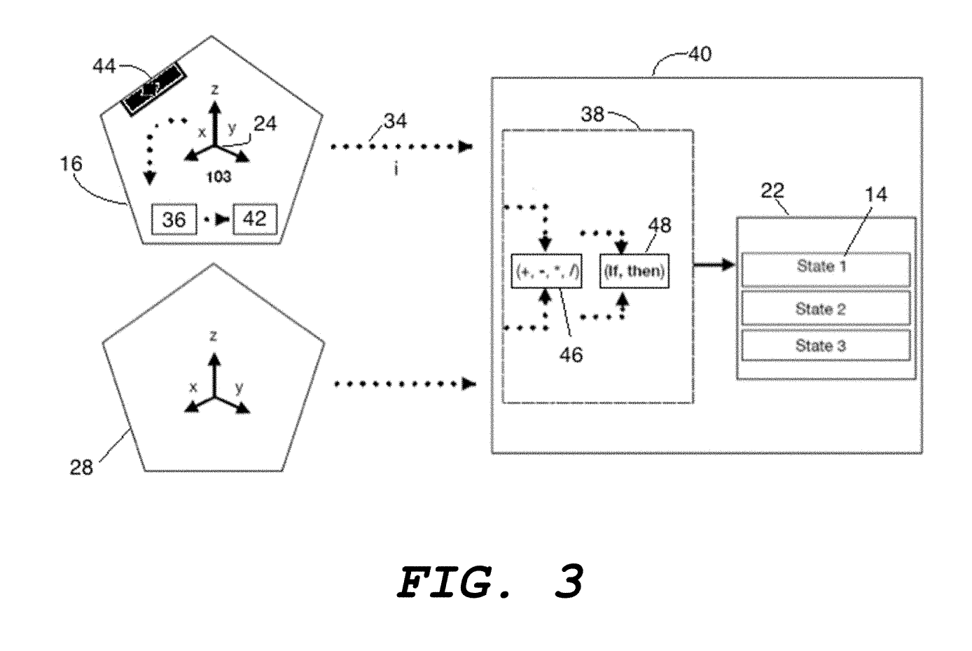

In some embodiments, the motion sensor 24 obtains measurements with nine degrees-of-freedom. In such embodiments, motion sensor 24 senses absolute orientation, acceleration, and gyrometric spin about each spatial axis. These parameters define a motion vector 34, shown in FIG. 3.

In other embodiments, the motion sensor 24 includes circuitry for causing one or more faces of the icosidodecahedron 16 to become touch-sensitive. In that case, the motion sensor 24 provides information from which one can derive motion of the icosidodecahedron 16 relative to a reference frame tied to, for example, a user's fingertip. Such motion could be the swipe of a finger across the face of the icosidodecahedron 16. Such motion could also represent the radially outward motion of the fingertip's boundary. This is because applied pressure causes the fingertip to spread out across the surface of the icosidodecahedron's face.

Referring to FIG. 3, the icosidodecahedron 16 also includes a microprocessor 36 that defines the motion vector 34 based on measurements provided by the motion sensor 24. The microprocessor 36 provides data representative of the motion vector 34 to a control patch 38 on a control computer 40 via a communication interface 42. In some embodiments, the communication interface 42 is a wireless interface, whereas in others, the communication interface 42 is a wired interface. A power supply 44, such as a battery, provides power to permit operation of the various components within the icosidodecahedron.

The control patch 38 continuously receives incoming motion vectors 34 and performs certain associative operations 46, followed by logic operations 48. The control patch 38 then assigns the output of these operations to a corresponding state vector 14 in the state space 22.

Kinematic parameters associated with each polyhedron can be used to control the communication of audio and/or video information. In one example, shown in FIG. 2, the performance artist 12, who in this case would likely be a disc jockey, might use an absolute orientation 50 of the first icosidodecahedron 16 to select a song 52 from a pre-determined list 54, thus cueing the song 52. The microprocessor 36 associated with the first polyhedron 26 could then test a measured gyrometric spin 56 against a threshold value 58. If the gyrometric spin 56 exceeds a threshold value 58, the song 52 is played.

Meanwhile the second polyhedron 28 modulates a low-pass audio filter 60. A composite function 62 of the second polyhedron's gyrometric spin and a measured acceleration thereof modulates the audible frequency range and dynamic range of the selected song 52, resulting in a unique audible output at an output device 64, such as a speaker.

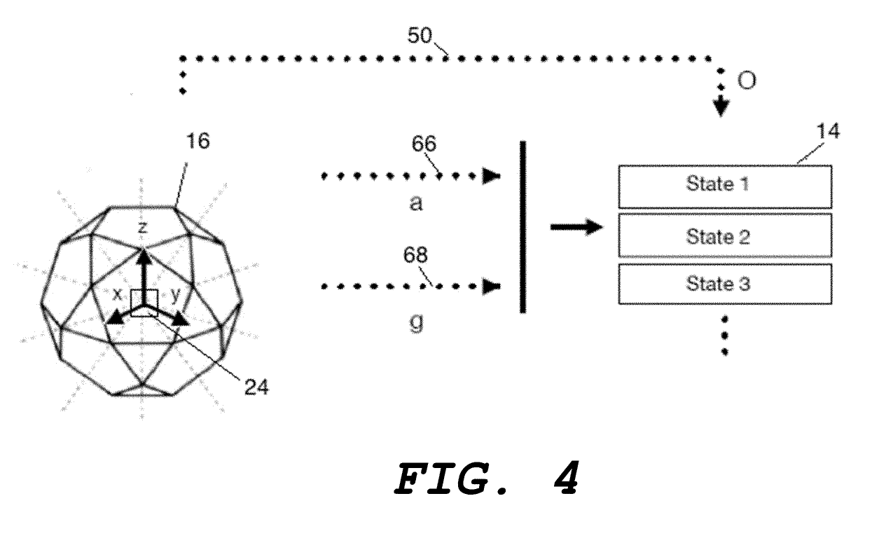

When the polyhedron set 10 has two or more elements, the result is a substantially richer state space 22. However, it is possible to have a polyhedron set 10 with only a single polyhedron 16 as shown in FIG. 4.

FIG. 4 illustrates several pathways by which physical parameters generated by a single icosidodecahedron 16 can generate a state vector 14. These physical parameters include absolute orientation 50, a linear acceleration threshold 66 and the gyrometric spin threshold 68. The absolute orientation 50 selects the state vector 14. If a particular measurement from the motion sensor 24 surpasses the linear acceleration threshold 66 and/or the gyrometric spin threshold 68, the control patch 38 initiates an appropriate state that corresponds to that measurement.

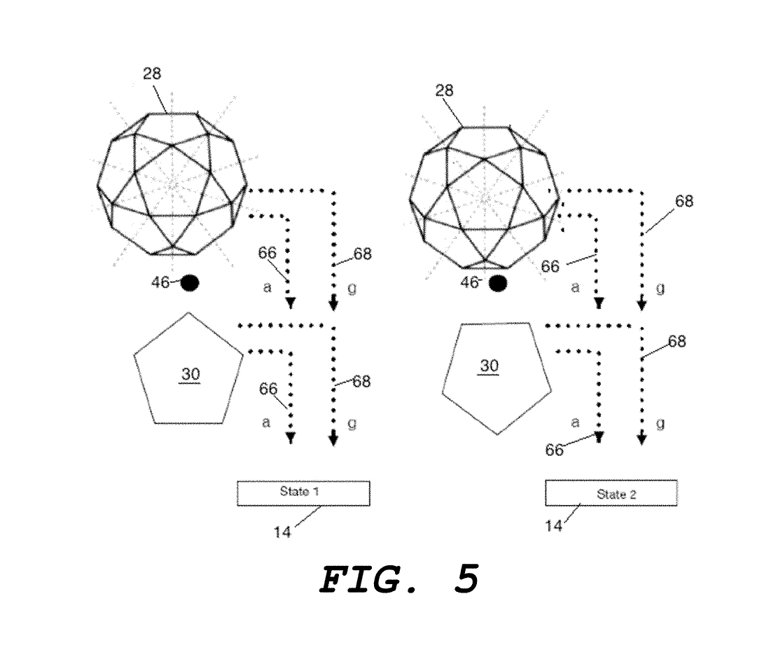

FIG. 5 illustrates permutations that arise in the case of first and second polyhedrons 28, 30 in a polyhedron set 10. The associative operation 46 composes an absolute orientation 50 of the first polyhedron 28 and the second polyhedron 30, defining a state vector 14 resulting from the specific permutation of the two polyhedrons' orientations, in conjunction with their respective linear acceleration thresholds 66 and gyrometric-spin thresholds 68.

The polyhedron set 10 communicates the inertial vectors 32 of its constituent elements to the control patch 38. The control patch 38 performs logic and associative operations 48, 46 illustrated in FIG. 3 to generate a state vector 14.

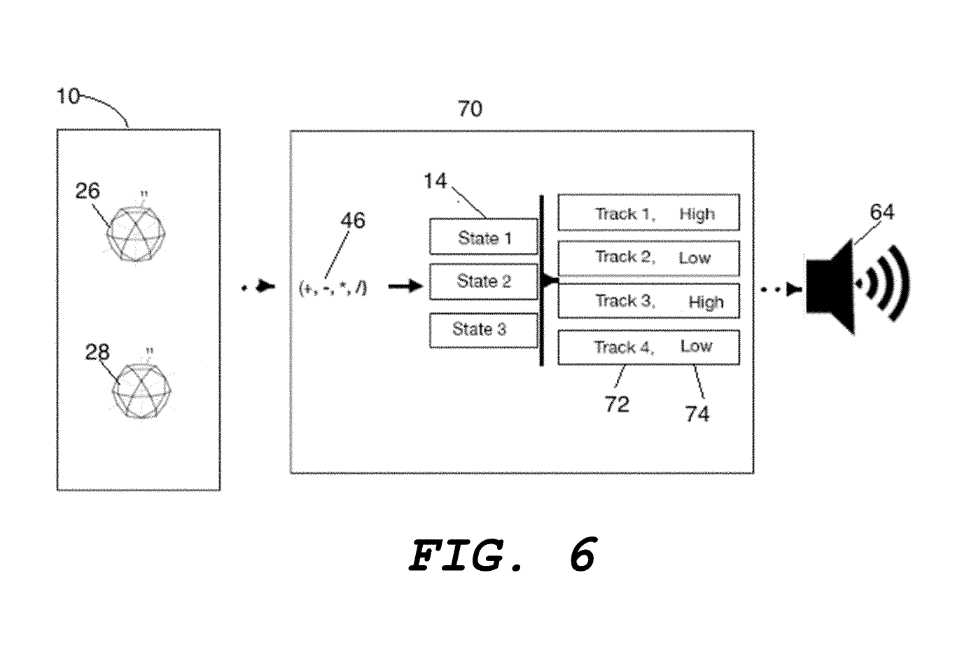

FIG. 6 illustrates an exemplary state-vector assignment process in which a digital audio/video workstation 70 receives the state vector 14 and plays the corresponding track 72 at the corresponding volume 84.

In other embodiments, the state vector 14 determines other parameters. Examples of other parameters that the state vector 14 may determine include resonant frequencies, delay periods, reverb times, track start/stop points, cross-fader distribution between parallel tracks, color saturation of video track output, image distortion gradient, and hue.

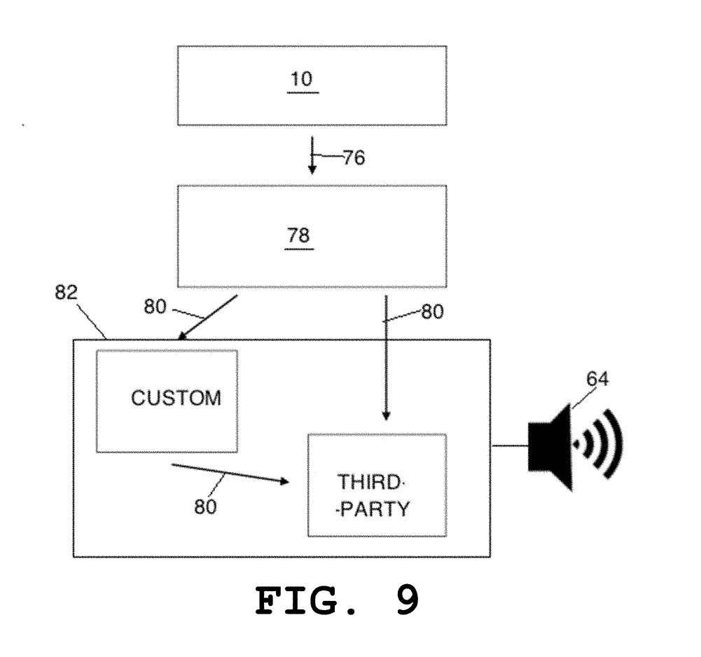

Referring now to FIG. 9, manipulation of one or more polyhedra from the polyhedron set 10 results in a raw sensor data 76. This raw sensor data 76 is provided to a first component 78. In the illustrated embodiment, the first component 78 is an applet configured to transform the raw sensor data 76 into a suitable formatted signal 80 and to forward such data to a suitable destination 82 via a wireless communication-link. A suitable formatted signal 80 is one that can be understood by typical third-party music-processor. Examples of a suitable protocol include MIDI and OSC.

The destination 82 is typically a music-processor that can carry out music-processing functions based on the formatted signal 80. The music-processor can be a conventional third-party music processor, a custom-built music processor, or a combination of both. Which of these three alternatives to choose depends on the nature of the function that the formatted signal 80 is intended to accomplish.

There are ultimately three possibilities: (1) the conventional third-party music processor can take the formatted signal 80 and perform all of the desired functions; (2) the conventional third-party music processor can take the formatted signal 80 and perform some of the desired functions; or (3) the conventional third-party music processor can take the formatted signal 80 and perform none of the desired functions.

If (1) is true, then the destination 82 can be the conventional third-party music processor. If (3) is true, then the destination 82 is the custom-built processor. These are both shown in FIG. 9.

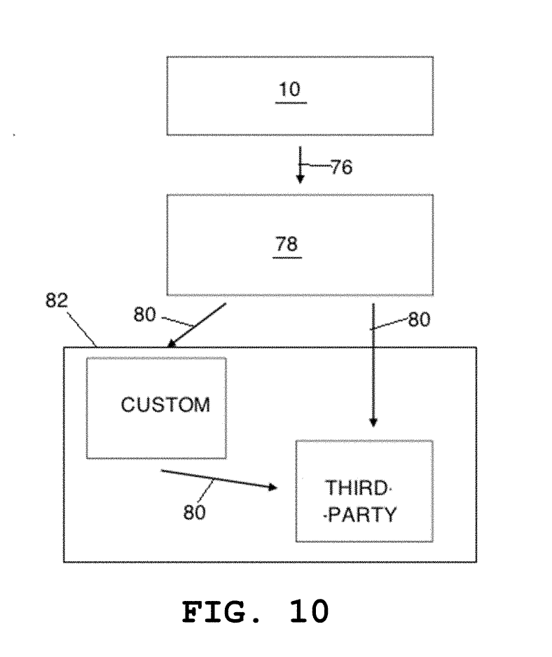

If (2) is true, the destination 82 can be a hybrid formed from a custom-built processor that communicates with the conventional third-party music processor so that the two cooperate to perform the desired functions. This is shown in FIG. 10.

Software for carrying out the foregoing functions is embodied in non-transitory and tangible computer-readable media made of tangible physical matter having mass. Such software is executed by a tangible digital computer that has mass, consumes energy, and generates waste heat. As such, an apparatus implementing the methods described herein has a tangible physical effect. Such tangible physical effects include controlling speakers 22 and displays to generate both acoustic waves and electromagnetic waves, the existence of which can be confirmed by suitable instrumentation.

In general, software exists in two forms: software per se and all other software, the latter being referred to as software per quod. To the extent the claims recite software, they are deemed to cover only software per quod and not software per se.

The apparatus claims are specifically limited to tangible physical objects that are not abstract. Method claims are specifically limited to non-abstract implementations. To the extent that apparatus claims are somehow construed to cover embodiments that are mere abstractions, those embodiments are hereby disclaimed. The claims only cover non-abstract embodiments. To the extent method claims are somehow construed to cover abstract methods, those two are hereby disclaimed. Applicant, acting as his own lexicographer, hereby defines “apparatus” and “method” as used herein to mean only a non-abstract apparatus and a non-abstract method and to specifically exclude from their meaning any apparatus or method that is abstract.

Having described the invention, and a preferred embodiment thereof, what is claimed as new, and secured by letters patent is:

1. An apparatus comprising a first polyhedron having a power supply, a microprocessor, a motion sensor, and a communication interface, wherein said motion sensor provides data indicative of motion relative to said polyhedron, and orientation of said first polyhedron, wherein said microprocessor determines a state vector corresponding to said data and provides said state data to said communication interface, and wherein said communication interface is configured to communicate said state vector to a control computer, wherein said first polyhedron is an icosidodecahedron.

2. The apparatus of claim 1, further comprising said control computer, wherein said control computer is configured to receive said state vector and to select an output corresponding to said state vector.

3. The apparatus of claim 2, wherein said output comprises an audio output.

4. The apparatus of claim 2, wherein said output comprises a video output.

5. The apparatus of claim 1, wherein said sensor comprises a 9-degree-of-freedom sensor.

6. The apparatus of claim 1, wherein said communication interface comprises a wireless interface.

7. The apparatus of claim 1, further comprising a second polyhedron, said second polyhedron comprising a power supply, a microprocessor, a motion sensor, and a communication interface, wherein said motion sensor provides data indicative of motion relative to said second polyhedron.

8. The apparatus of claim 7, further comprising said control computer, wherein said control computer is configured to receive said state vectors from said first and second polyhedra and to select an output corresponding to said state vectors.

9. The apparatus of claim 2, wherein said output comprises a selection of content to be output on at least one of a speaker and a display.

10. The apparatus of claim 2, wherein said output is selected from the group consisting of a resonant frequency, a delay period, a reverb time, a track start point, a track stop point, a cross-fader distribution between parallel tracks, color saturation of video track output, an image distortion gradient, and hue.

11. The apparatus of claim 7, wherein said first and second polyhedra are the same kind of polyhedron.

12. The apparatus of claim 7, wherein said first and second polyhedra are different kinds of polyhedra.

13. The apparatus of claim 1, wherein said motion sensor comprises an accelerometer.

14. The apparatus of claim 1, wherein said motion sensor comprises an inertial measurement unit.

15. The apparatus of claim 1, wherein said motion sensor comprises a capacitive touch sensor.

16. The apparatus of claim 1, wherein said icosidodecahedron comprises a truncated icosidodecahedron.

17. The apparatus of claim 1, wherein said icosidodecahedron comprises a complete icosidodecahedron.

18. A method comprising receiving a signal from a motion sensor that is disposed within a first polyhedron having a power supply, a microprocessor, said motion sensor, and a communication interface, said signal comprising data indicative of motion relative to said polyhedron and orientation of said first polyhedron, receiving, via said communication interface and from said microprocessor, a state vector corresponding to said data, wherein said first polyhedron is an icosidodecahedron.
